(19) United States
(12) Patent Application Publication
(10) Pub. No.: US 2025/0319796 A1
(43) Pub. Date: Oct. 16, 2025

(54) VEHICLE

(71) Applicant: TOYOTA JIDOSHA KABUSHIKI KAISHA, Toyota-shi (JP)

(72) Inventors: Kotaro MAEDA, Toyota-shi (JP); Takaoki OGAWA, Toyota-shi (JP); Tomohiro OGAWA, Miyoshi-shi (JP); Tomohito ENOKI, Toyota-shi (JP); Shinnosuke SAKO, Toyota-shi (JP)

(73) Assignee: TOYOTA JIDOSHA KABUSHIKI KAISHA, Toyota-shi (JP)

(21) Appl. No.: 19/018,327

(22) Filed: Jan. 13, 2025

(30) Foreign Application Priority Data
Apr. 16, 2024 (JP) 2024-065967

(51) Int. Cl. B60L 58/33; B60K 11/08

(52) U.S. Cl. CPC B60L 58/33; B60K 11/085

(57) ABSTRACT

The vehicle includes a vehicle body, a fuel cell mounted inside the vehicle body, a radiator mounted inside the vehicle body and circulating a cooling medium with the fuel cell, an air introduction port provided at a front portion of the vehicle body for introducing outside air into the radiator, and a control device for adjusting an angle of the air introduction port in the vertical direction in the air introduction direction in accordance with a pitch angle of the vehicle body.

### CROSS-REFERENCE TO RELATED APPLICATION

This application claims priority to Japanese Patent Application No. 2024-065967 filed on Apr. 16, 2024, incorporated herein by reference in its entirety.

### BACKGROUND

### 1. Technical Field

The technology disclosed herein relates to a vehicle.

### 2. Description of Related Art

Japanese Unexamined Patent Application Publication No. 2023-140126 (JP 2023-140126 A) discloses a vehicle. The vehicle includes a vehicle body, a fuel cell mounted inside the vehicle body, a radiator mounted inside the vehicle body and configured to circulate a cooling medium with the fuel cell, and an air introduction port provided at a front portion of the vehicle body and configured to introduce outside air into the radiator.

### SUMMARY

In the vehicle of JP 2023-140126 A, outside air is introduced into the inside of the vehicle body, specifically, into the radiator, via the air introduction port provided at the front portion of the vehicle body. In many cases, the angle of the air introduction direction of the air introduction port with respect to the vertical direction is set based on a state in which the vehicle body is parallel to a road surface. However, the vehicle body is inclined in the front-rear direction when a load is mounted on the vehicle body. That is, the pitch angle of the vehicle body changes. When the pitch angle of the vehicle body changes, the air introduction direction of the air introduction port also changes. As a result, the amount of air introduced into the radiator from the air introduction port also changes. The air introduction direction of the air introduction port means a direction in which the area of the opening of the air introduction port is maximized when the air introduction port is projected onto a plane perpendicular to the direction.

The present specification provides a technology capable of introducing an appropriate amount of air into a radiator even when a pitch angle of a vehicle body changes.

In a first aspect disclosed herein,
a vehicle may include:
a vehicle body;
a fuel cell mounted inside the vehicle body;
a radiator mounted inside the vehicle body and configured to circulate a cooling medium with the fuel cell;
an air introduction port provided at a front portion of the vehicle body and configured to introduce outside air into the radiator; and
a control device configured to adjust an angle of an air introduction direction of the air introduction port with respect to a vertical direction according to a pitch angle of the vehicle body.

In the above configuration, the control device adjusts the angle of the air introduction direction with respect to the vertical direction according to the pitch angle of the vehicle body. Therefore, it is possible to introduce an appropriate amount of air into the radiator even when the pitch angle of the vehicle body changes, for example, according to the load on the vehicle body.

In a second aspect, in the first aspect,
the control device may be configured to adjust the angle of the air introduction direction with respect to the vertical direction in at least two levels according to the pitch angle.

In the above configuration, the angle of the air introduction direction with respect to the vertical direction is adjusted stepwise for the pitch angle continuously changing according to the weight of the load. Therefore, the mechanism required for the adjustment can be simply structured. As another aspect, the control device may continuously adjust the angle of the air introduction direction with respect to the vertical direction according to the pitch angle of the vehicle body.

In a third aspect, in the first or second aspect,
the control device may be configured to:
determine the pitch angle while the vehicle is stopped; and
adjust the angle of the air introduction direction with respect to the vertical direction using the pitch angle determined while the vehicle is stopped.

During traveling of the vehicle, the pitch angle of the vehicle body may temporarily change, for example, according to the traveling state and/or the road surface state. With the above configuration, it is possible to adjust the angle of the air introduction direction with respect to the vertical direction without undergoing such a temporary change in the pitch angle.

In a fourth aspect, in any one of the first to third aspects, the vehicle may further include
an inclination sensor configured to detect the pitch angle.

The control device may be configured to adjust the angle of the air introduction direction with respect to the vertical direction based on the pitch angle detected by the inclination sensor.

With the above configuration, it is possible to appropriately adjust the angle of the air introduction direction with respect to the vertical direction according to the actual pitch angle of the vehicle body. As another aspect, the pitch angle of the vehicle body may be calculated or estimated using one or more other indices (e.g., the weight of the load).

In a fifth aspect,
a vehicle may include:
a vehicle body on which a load is mounted at a rear portion;
a fuel cell mounted inside the vehicle body;
a radiator mounted inside the vehicle body and configured to circulate a cooling medium with the fuel cell;
an air introduction port provided at a front portion of the vehicle body and configured to introduce outside air into the radiator; and
a control device configured to adjust an angle of an air introduction direction of the air introduction port with respect to a vertical direction according to a loading amount of the load mounted on the vehicle body.

In the above configuration, the control device adjusts the angle of the air introduction direction of the air introduction port with respect to the vertical direction according to the amount of the load mounted on the vehicle body. The pitch angle of the vehicle body changes according to the weight of the load. Therefore, it is possible to introduce an appropriate amount of air into the radiator even when the pitch angle of the vehicle body changes according to the load on the vehicle body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle 2 according to a first embodiment;

FIG. 2 is a schematic diagram of a cooling system 20 according to a first embodiment;

FIG. 3 is a diagram showing a state in which the vehicle 2 is inclined in the first embodiment;

FIG. 4 shows, in a first embodiment, a cooling system 20 when the vehicle 2 is inclined; and

FIG. 5 is a schematic diagram of a vehicle 102 according to a second embodiment.

### DETAILED DESCRIPTION OF EMBODIMENTS

### Example 1

The vehicle 2 will be described with reference to FIGS. 1 to 4. The vehicle 2 is truck-type fuel cell electric vehicle. The vehicle 2 includes a vehicle body 10, a loading platform 12, a front wheel 14, a rear wheel 16, a fuel cell stack 18 (see FIG. 2), a cooling system 20 (see FIG. 2), an inclination sensor 22, and a control device 24. The front wheels 14 and the rear wheels 16 are attached to the vehicle body 10. The loading platform 12 is attached to the vehicle body 10 at a rear portion of the front wheel 14. The inclination sensor 22 is mounted on the vehicle body 10 and detects a pitch angle of the vehicle body 10. The pitch angle is an inclination angle of the vehicle body 10 with respect to the front-rear direction.

An air introduction portion 26 of FIG. 2 is provided at a lower front portion of the vehicle body 10. The air introduction portion 26 introduces outside air into the vehicle body 10. The air introduction portion 26 includes a frame 28 and a plurality of fins 30. The frame 28 defines an air introduction port 32. The plurality of fins 30 are rotatably supported by the frame 28. The plurality of fins 30 are arranged at equal intervals in the up-down direction. The plurality of fins 30 can rotate with an axis A extending in the left-right direction as a rotation axis. The plurality of fins 30 determine the air introduction direction of the air introduction port 32.

Here, the air introduction direction of the air introduction port 32 means a direction in which the area of the opening portion (excluding the portions of the plurality of fins 30) of the air introduction port 32 is maximized when the air introduction port 32 (including the plurality of fins 30) is projected onto a plane perpendicular to the direction. In other words, the air introduction direction of the air introduction port 32 means a direction in which an area of a range in which the inside of the vehicle body 10 can be visually recognized through the air introduction port 32 is maximized when the air introduction port 32 is viewed along the direction.

The fuel cell stack 18 and the cooling system 20 are mounted inside the vehicle body 10. The fuel cell stack 18 is a device that generates electric power by a chemical reaction of hydrogen and oxygen. The fuel cell stack 18 includes a plurality of unit cells (not shown). The electric power generated by the fuel cell stack 18 is supplied to, for example, a traveling motor (not shown) of the vehicle 2.

The cooling system 20 is a system for cooling the fuel cell stack 18 using a cooling medium flowing through the cooling system 20. By way of example, the coolant is a cooling medium. The cooling system 20 includes a radiator 40, a fan 42 provided in the vicinity of the radiator 40, a pump 44, an ion exchanger 46, a valve 48, a forward pipe 50, a return pipe 52, and a bypass pipe 54. The fan 42 sends wind toward the radiator 40. The upstream end of the forward pipe 50 is connected to the downstream end of the refrigerant flow path of the radiator 40, and the downstream end of the forward pipe 50 is connected to the upstream end of the refrigerant flow path of the fuel cell stack 18. The upstream end of the return pipe 52 is connected to the downstream end of the refrigerant flow path of the fuel cell stack 18, and the downstream end of the return pipe 52 is connected to the upstream end of the refrigerant flow path of the radiator 40. The bypass pipe 54 connects the middle of the forward pipe 50 and the middle of the return pipe 52. The pump 44 is provided in the forward pipe 50. The pump 44 is provided closer to the fuel cell stack 18 than the connection portion between the forward pipe 50 and the bypass pipe 54. The ion exchanger 46 is provided in the bypass pipe 54. The valve 48 is provided at a connection portion between the return pipe 52 and the bypass pipe 54. The valve 48 adjusts the ratio between the amount of the cooling medium flowing from the return pipe 52 to the radiator 40 and the amount of the cooling medium flowing from the return pipe 52 to the ion exchanger 46.

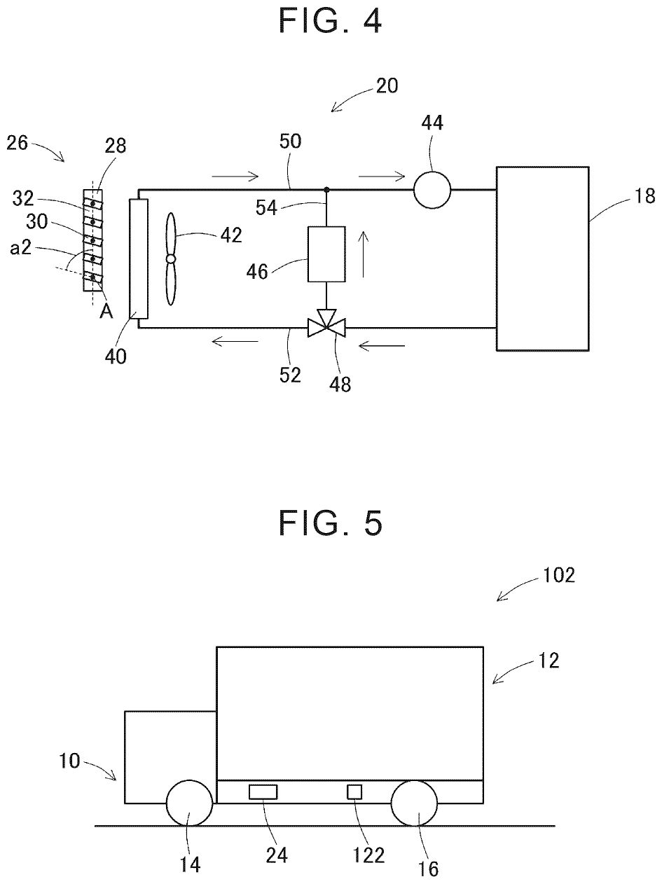

The control device 24 of FIG. 1 includes a CPU and memories such as a ROM and a RAM. The control device 24 controls the operation of each component of the vehicle 2. The control device 24 is configured to be capable of performing a cooling operation of controlling the operation of the cooling system 20 to cool the fuel cell stack 18. The memory of the control device 24 stores a pitch angle of the vehicle 2 while the vehicle is stopped and a first angle determination table for determining an angle of the fin 30 of the air introduction portion 26 in the vertical direction based on the pitch angle. Hereinafter, the angle of the fin 30 in the up-down direction will be simply referred to as an “angle of the fin 30”. The first angle determination table is a table for adjusting the angle of the fin 30 stepwise. For example, in the first angle determination table, the angle of the fin 30 corresponding to the case where the pitch angle is 0° or more and less than the first predetermined angle is the first angle a1 (see FIG. 2). For example, in the first angle determination table, the angle of the fin 30 corresponding to the pitch angle being equal to or greater than the first predetermined angle and less than the second predetermined angle is the second angle a2 (see FIG. 4). For example, in the first angle determination table, the angle of the fin 30 corresponding to the case where the pitch angle is greater than or equal to the second predetermined angle and less than the third predetermined angle is the third angle. The second predetermined angle is greater than the first predetermined angle. The second angle a2 is greater than the first angle a1 and the third angle is greater than the second angle a2. As described above, in the present embodiment, the angle (i.e., the air introduction direction) of the fin 30 is adjusted in three stages. In the modified example, the angle of the fin 30 may be adjustable to two or four or more stages. The first angle determination table is set so that the introduction efficiency of the traveling wind in the case where the pitch angle is 0° and the introduction efficiency of the traveling wind in the case where the pitch angle is larger than 0° are substantially the same.

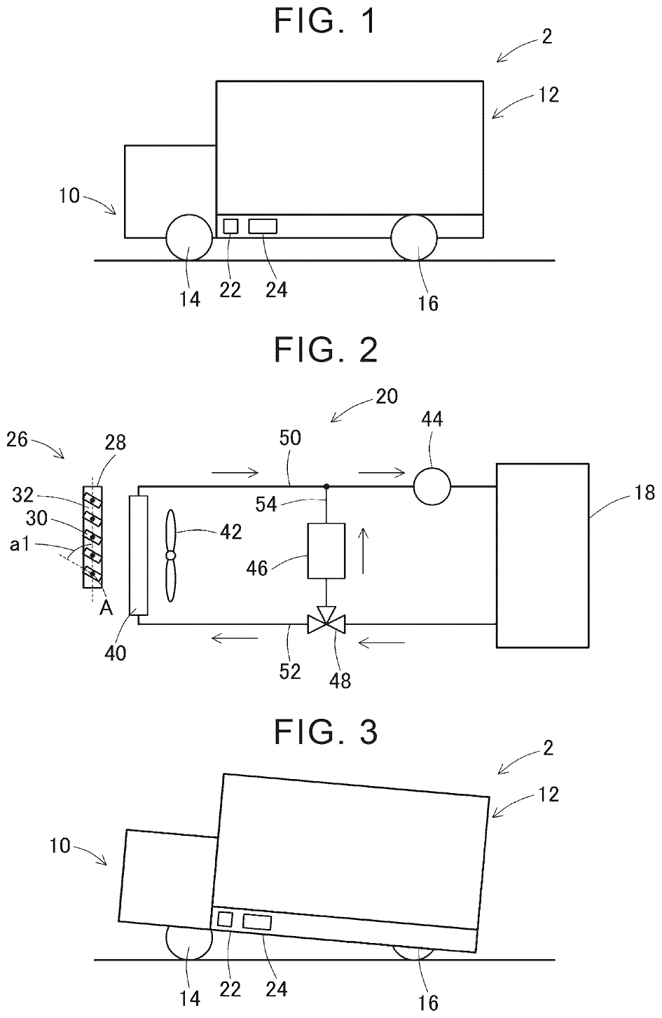

The cooling operation performed by the control device 24 will be described. The control device 24 executes a cooling operation during traveling. First, the control device 24 drives the pump 44. As a result, the cooling medium circulates between the fuel cell stack 18 and the radiator 40. The control device 24 drives the fan 42 and inclines the fin 30 with respect to the vertical direction. The control device 24 uses the pitch angle stored in the memory and the first angle determination table to set the angle of the fin 30. For example, as shown in FIG. 1, the control device 24 determines the angle of the fins 30 as the first angle a1 when the pitch angle stored in the memories is 0°. Then, as shown in FIG. 2, the control device 24 operates the fin 30 so that the angle of the fin 30 becomes the first angle a1. Further, for example, as illustrated in FIG. 3, when the pitch angle stored in the memory is equal to or greater than the first predetermined angle and less than the second predetermined angle, the control device 24 determines the angle of the fin 30 as the second angle a2. Then, as shown in FIG. 4, the control device 24 operates the fin 30 so that the angle of the fin 30 becomes the second angle a2. As a result, the outside air is introduced into the inside of the vehicle body 10, specifically, the radiator 40, through the air introduction port 32 of the air introduction portion 26. Also, air is supplied to the radiator 40 by driving the fan 42. In response to air being introduced into the radiator 40, the cooling medium flowing through the radiator 40 is cooled. Since the cooled cooling medium is supplied to the fuel cell stack 18, the fuel cell stack 18 is cooled.

In response to the load being mounted on the vehicle body 10, the vehicle body 10 is inclined in the front-rear direction, and the pitch angle of the vehicle body 10 changes. When the pitch angle of the vehicle body 10 changes, the air introduction direction of the air introduction port 32 also changes. As a result, the introduction efficiency of the traveling wind into the inside of the vehicle body 10, that is, the amount of air introduced into the radiator 40 from the air introduction port 32 also changes. Therefore, in the present embodiment, the angle of the fin 30 (that is, the angle in the air introduction direction) is adjusted according to the pitch angle of the vehicle body 10. Therefore, even when the pitch angle of the vehicle body 10 changes, it is possible to suppress a decrease in the efficiency of introducing the traveling wind into the vehicle body 10.

As described above, the vehicle 2 includes the vehicle body 10, the fuel cell stack 18 (an example of a “fuel cell”), the radiator 40 through which the cooling medium circulates with the fuel cell stack 18, the air introduction port 32, and the control device 24. The fuel cell stack 18 is mounted inside the vehicle body 10. The radiator 40 is mounted inside the vehicle body 10. The air introduction port 32 is provided at a front portion of the vehicle body 10, and introduces outside air into the radiator 40. The control device 24 adjusts the angle of the air introduction port 32 in the vertical direction in the air introduction direction in accordance with the pitch angle of the vehicle body 10.

According to the above configuration, the control device 24 adjusts the angle in the vertical direction in the air introduction direction in accordance with the pitch angle of the vehicle body 10. Therefore, even when the pitch angle of the vehicle body 10 changes according to the load on the vehicle body 10, for example, an appropriate amount of air can be introduced into the radiator 40.

In addition, the control device 24 adjusts the angle in the vertical direction of the air introduction direction in three stages according to the pitch angle.

According to the above configuration, since the angle in the vertical direction of the air introduction direction is adjusted stepwise with respect to the pitch angle continuously changing according to the weight of the load, the mechanism required for the adjustment can be simply configured.

In addition, the control device 24 specifies the pitch angle while the vehicle 2 is stopped, and adjusts the angle in the vertical direction in the air introduction direction by using the pitch angle specified during the stop.

During traveling of the vehicle 2, the pitch angle of the vehicle body 10 may temporarily change according to the traveling state, the road surface state, and the like. According to the above configuration, it is possible to adjust the angle in the vertical direction in the air introduction direction without undergoing such a temporary change in the pitch angle.

The vehicle 2 further includes an inclination sensor 22 that detects a pitch angle. The control device 24 adjusts the angle in the vertical direction of the air introduction direction based on the pitch angle detected by the inclination sensor 22.

According to the above configuration, it is possible to appropriately adjust the air introduction direction in accordance with the actual pitch angle of the vehicle body 10.

### Second Embodiment

The vehicle 2 of the second embodiment will be described with reference to FIG. 5. As illustrated in FIG. 5, the vehicle 102 of the second embodiment includes a weight sensor 122 instead of the inclination sensor 22. The weight sensor 122 is mounted on the vehicle body 10 and detects the weight of the load loaded on the loading platform 12.

A second angle determination table for determining the angle of the fin 30 based on the weight detected by the weight sensor 122 is stored in the memory of the control device 24 of the present embodiment. The second angle determination table is configured to determine the angle of the fin 30 in three stages, similar to the angle determination table of the first embodiment. In the second angle determination table, the angle of the fin 30 is set to be larger as the weight is larger. For example, as shown in FIG. 1, when the weight is 0 kg, the angle of the fin 30 is set to a first angle a1 (see FIG. 2), and when the weight is a predetermined weight greater than 0 kg, the angle of the fin 30 is set to a second angle a2 (see FIG. 4).

As described above, the vehicle 2 includes the vehicle body 10, the fuel cell stack 18 (an example of a “fuel cell”), the radiator 40 through which the cooling medium circulates with the fuel cell stack 18, the air introduction port 32, and the control device 24. The fuel cell stack 18 is mounted inside the vehicle body 10. The radiator 40 is mounted inside the vehicle body 10. The air introduction port 32 is provided at a front portion of the vehicle body 10, and introduces outside air into the radiator 40. The control device 24 adjusts the angle of the air introduction port 32 in the vertical direction in the air introduction direction in accordance with the loading amount of the load mounted on the vehicle body 10.

According to the above configuration, the control device 24 adjusts the angle in the vertical direction in the air introduction direction in accordance with the loading amount of the load mounted on the vehicle body 10. The pitch angle of the vehicle body 10 varies according to the weight of the load. Therefore, even when the pitch angle of the vehicle body 10 changes according to the loading portion on the vehicle body 10, an appropriate amount of air can be introduced into the radiator 40.

Although specific examples of the disclosure have been described in detail above, the examples are merely examples and do not limit the scope of claims. The technique described in the claims includes various modifications and variations of the specific examples exemplified above.

(First modification) the control device 24, by adjusting the angle in the vertical direction of the frame 28 of the air introduction portion 26 may adjust the angle in the vertical direction of the air introduction direction.

(Second modification) the control device 24, depending on the pitch angle, it may be adjusted continuously the angle of the fin 30.

(Third modification) The control device 24, in accordance with the pitch angle of the vehicle 2 in running, may adjust the angle in the vertical direction of the air introduction direction. Further, the control device 24 may specify a time-averaged pitch angle of the vehicle 2 during traveling, and adjust an angle in the vertical direction in the air introduction direction according to the pitch angle.

(Fourth modification) the control device 24, the weight sensor, using a distance sensor or the like, may detect the pitch angle of the vehicle 2.

(Fifth modification) the “vehicle” is not limited to a truck, and may be a passenger car, a bus, or the like.

The technical elements described in this specification or in the drawings exhibit technical utility alone or in various combinations, and are not limited to the combinations described in the claims at the time of filing. Further, the technology illustrated in the present specification or the drawings can achieve a plurality of objects at the same time, and has technical usefulness by achieving one of the objects.

What is claimed is:

1. A vehicle comprising:
a vehicle body;
a fuel cell mounted inside the vehicle body;
a radiator mounted inside the vehicle body and configured to circulate a cooling medium with the fuel cell;
an air introduction port provided at a front portion of the vehicle body and configured to introduce outside air into the radiator; and
a control device configured to adjust an angle of an air introduction direction of the air introduction port with respect to a vertical direction according to a pitch angle of the vehicle body.

2. The vehicle according to claim 1, wherein the control device is configured to adjust the angle of the air introduction direction with respect to the vertical direction in at least two levels according to the pitch angle.

3. The vehicle according to claim 1, wherein the control device is configured to:
determine the pitch angle while the vehicle is stopped; and
adjust the angle of the air introduction direction with respect to the vertical direction using the pitch angle determined while the vehicle is stopped.

4. The vehicle according to claim 1, further comprising an inclination sensor configured to detect the pitch angle, wherein the control device is configured to adjust the angle of the air introduction direction with respect to the vertical direction based on the pitch angle detected by the inclination sensor.

5. A vehicle comprising:
a vehicle body on which a load is mounted at a rear portion;
a fuel cell mounted inside the vehicle body;
a radiator mounted inside the vehicle body and configured to circulate a cooling medium with the fuel cell;
an air introduction port provided at a front portion of the vehicle body and configured to introduce outside air into the radiator; and
a control device configured to adjust an angle of an air introduction direction of the air introduction port with respect to a vertical direction according to a loading amount of the load mounted on the vehicle body.
